(19) United States
(12) Patent Application Publication
(10) Pub. No.: US 2004/0011547 A1
(43) Pub. Date: Jan. 22, 2004

(54) Cable Guiding

(76) Inventor: Colin Morgan Wright, (US)

Correspondence Address: BURNS DOANE SWECKER & MATHIS L L P, POST OFFICE BOX 1404, ALEXANDRIA, VA, 22313-1404, US

(21) Appl. No.: 10/433,049

(22) PCT Filed: Dec. 21, 2001
(86) PCT No.: PCT/GB01/05757

(30) Foreign Application Priority Data
Dec. 22, 2000 (GB) 0031583.8

(51) Int. Cl. H02G 3/08

(52) U.S. Cl. 174/50

(57) ABSTRACT

A rack suitable for housing connections of cable in a telecommunications or data communications network includes a plurality of cable guides (3). The guide (3) includes a first end portion (4) mounted on a mounting rail (1), a cable guiding portion (5) extending away from the mounting rail (1) and a cable retaining portion (6) provided with a radially extending arm (8), the radially outer end (8b) of which is resiliently displaceable.

The invention relates to cable guiding on a rack suitable for housing connections of cables in a telecommunications or data communications network. The invention more particularly relates to a rack including cable guides, to a cable guide for use on such a rack, to a flat pack for assembling on site into such a rack and to a method of making cable connections in such a rack. The rack may be clad with panels and thus take the form of what is referred to herein as an enclosure, but it may also be used without such panels.

Racks commonly have many cables passing in and out of them and it is desirable to maintain those cables in an orderly manner and to guide them along suitable paths. For that purpose it is already known to provide cable guides of various kinds on a rack. Such cable guides may also serve the purpose of enabling the length of a particular cable path to be adjusted to accommodate a particular length of cable; such an arrangement may for example be useful when connections are to be made between two racks placed side-by-side.

Desirably, a cable guidance system is simple and inexpensive but also effective and able to adapt to a wide variety of different conditions which may arise during use. Hitherto it has generally proved difficult to provide a rack that includes a cable guidance system that provides even the majority of the desirable features just referred to and the present invention seeks to overcome or mitigate that problem.

In our earlier International Application. No. PCT/GB 00/02484, the contents of which is incorporated herein by reference, a cable guidance system is described that has many advantageous features. The present invention seeks to develop and improve further the invention described in that earlier International Application.

According to the invention there is provided a rack suitable for housing connections of cables in a telecommunications or data communications network, the rack including a plurality of cable guides mounted on an elongate cable guide mounting member on which a plurality of cable guide mountings are provided, each cable guide comprising a first end portion mounted on the mounting member at a respective cable guide mounting, a cable guiding portion extending away from the mounting member and a second end portion provided at the opposite end of the cable guiding portion to the first end portion, the second end portion of the cable guide being provided with a radially extending arm, the radially outer end of which is resiliently displaceable.

By providing a radially extending arm which is resiliently displaceable it becomes possible to arrange a cable guide in a position in which cables are retained with certainty in a desired region by the radially extending arm but can be moved, without any change in the position of the arm, into the desired region by a user applying sufficient force to displace the arm against its resilient bias, the arm automatically returning after such displacement to its previous cable retaining position.

In principle, the feature of resilient displaceability may be provided in many different ways including for example the provision of pivotally mounted and spring biased parts. Preferably, however, the radially extending arm is resiliently deformable to provide the resilient displacement of the radially outer end of the arm. The deformation of the arm may be evenly distributed along its entire length or may be concentrated towards the radially outer end of the arm.

Preferably the radially outer end of the arm is resiliently displaceable in a direction towards the mounting member. It is also preferred that the radially outer end of the arm is resiliently displaceable in such a direction as to alter the radial extent of the arm. As will be clear from the description below with reference to the drawings, each of these directions of displacement are advantageous and preferably both are present.

The radially extending arm preferably comprises a first root portion extending in a direction radially outwardly and away from the mounting member, and a second end portion extending in a direction radially outwardly away from the root position and towards the mounting member. A smoothly curved bridging face is preferably provided on a face extending between the first root portion and the second end portion of the radially extending arm, the bridging face defining the portion of the arm furthest from the mounting member. With such an arrangement, a user can pass a cable past the radially extending arm by resiliently displacing the radially outer end of the arm with a camming action of the cable on the bridging face of the arm.

Preferably the part of the cable guide furthest from the mounting member is a portion of the radially extending arm and, more preferably, is the bridging face of the radially extending arm. In that case, resilient displacement of the arm towards the mounting member reduces the amount by which the cable guide as a whole projects from the mounting member.

Preferably, the radially extending arm is a first arm and the second end portion of each cable guide is provided also with a second radially extending arm diametrically opposite the first arm. The overall shape of the cable guide may be generally a Y shape or a T shape. The radially outer end of the second radially extending arm is preferably also resiliently displaceable. As in the case of the first arm, the resilient displaceability may be provided in various ways, but it is preferred that the second radially extending arm is resiliently deformable, and that the radially outer end of the second radially extending arm is resiliently displaceable in a direction towards the mounting member and/or in such a direction as to alter the radial extent of the arm. By providing two diametrically opposite radially extending arms on each cable guide it is possible to arrange cable guides in a row with respective arms of adjacent cable guides terminating immediately adjacent to one another or in contact with one another, enabling the cable guides to be used in a variety of arrangements as will become clear from the description below with references to the drawings.

It is possible for the first and second radially extending arms to be of the same length but preferably the radial extent of the second radially extending arm from the central axis of the cable guide is one half of the radial extent of the first radially extending arm from the same axis. Furthermore the ratio of twice the radial extent of the first radially extending arm to the spacing of the cable guide mountings is preferably approximately an integer, more preferably the integer two. With a ratio of two, if the cable guides are mounted at alternate cable guide mountings, then the outer ends of the first radially extending arms of adjacent cable guides will be immediately adjacent to one another if the arms are positioned to extend towards one another, whilst if the cable guides are mounted at adjacent cable guide mountings, then the outer ends of the second radially extending arms of adjacent cable guides will be immediately adjacent to one another if those arms are positioned to extend towards one another.

The mounting system for mounting the cable guides may take various forms but it is especially preferred that the mounting portion includes a mounting head connected to the cable guide by a neck and that the cable guide mountings are defined by holes in the elongate mounting member, the head being insertable in a first orientation of the cable guide through a selected one of the holes defining the cable guide mountings and then rotatable to a second orientation in which the head is unable to pass back through the selected hole. With such a system it can be a very simple operation, without any tools, to attach a cable guide to a mounting on the rack or to detach it from such a mounting. Preferably rotation of the cable guide in use serves to secure the guide to a lamellar part around the hole through which the guide is inserted; if desired the rotation can cause a progressively increasing clamping action. In that way, simple rotation of the cable guide by hand can lead to a secure fixing of the guide on the rack.

Preferably, the cable guiding portion of each cable guide is generally in the form of a rod; preferably the rod is of substantially circular cross-section.

The second end portion of the cable guide may be fixed to and formed integrally with the remainder of the cable guide. According to an especially preferred feature of the invention, however, the second end portion is adjustably mounted relative to the first end portion of the cable guide; preferably it is rotatably mounted relative to the first end portion of the cable guide. The first end portion and the cable guiding portion of the cable guide are preferably integral with one another. Preferably the second end portion is arranged to be mounted on the cable guiding portion by fitting it into or over a free end of the cable guiding portion.

The second end portion may be continuously and infinitely adjustable around the first end portion or it may be adjustable between a plurality of predetermined different positions. By providing the adjustment facility referred to above it becomes possible to arrange for the radially extending arm to present little or no obstruction to the initial placing of a cable around the guide but thereafter, following adjustment of the second end portion, to obstruct removal of the cable and thereby retain the cable in its desired location.

In addition to the second end portion, a guide may further include one or more cable dividers projecting radially from the guiding portion of the guide. The cable dividers may be in the form of discs. Generally it is preferred that the discs are circular and extend around the whole of the cable guiding portion at a substantially constant width, but it is also possible for the lateral projection to be greater in some directions than in others.

The cable dividers may be a friction fit on the cable guiding portion of the guide.

Parts of the cable guides may be apertured to facilitate the connection of cable ties between adjacent parts of the same cable guide or parts of adjacent cable guides.

The elongate cable guide mounting member will usually extend vertically but may extend horizontally across all or part of the frame between one side and the other or horizontally through all or part of the depth of the frame between the back and the front; usually the cable guide mountings are provided on a vertical face of a member, but they may also be provided on a horizontal face. Thus there is considerable flexibility regarding the locations of the cable guide mountings. Preferably at least some of the cable guide mountings are arranged in one or more rows, more preferably in one or more vertical rows.

The rack may further include cables which are connected to terminals in the enclosure, the paths of one or more of the cables being guided by one or more of the plurality of cable guides which are mounted on at least some of the cable guide mountings.

The term “enclosure” used above should not be taken to imply that there are continuous walls defining a fully closed space. Often it is desirable for there to be panels enclosing a substantial part of the enclosure in order both for the connections to be protected and for persons to be protected from the connections. It should be understood, however, that it is within the scope of the present invention to provide an enclosure with only some panels or a rack without any panels.

In one embodiment of the invention the rack includes a side panel and the cable guides mounted on the elongate cable guide mounting member extend away from the mounting member towards the side panel with a part of the radially extending arm of each cable guide being disposed immediately adjacent to the side panel and preferably contacting the side panel. In that case, the radially extending arm and side panel together act to prevent accidental passage of a cable between them, but the radially outer end of the arm is able to be resiliently displaced by a user pressing on a cable between the arm and the side panel.

In another embodiment of the invention the rack is placed next to another rack as defined above, elongate cable guide mounting members being provided on each of the racks in confronting relationship such that the radially extending arm of a cable guide on the mounting member of one rack can be disposed immediately adjacent to the radially extending arm of a cable guide on the mounting member of the other rack and preferably in contact with the radially extending arm. In that case, the radially extending arms together act to prevent accidental passage of a cable between them but the radially outer ends of the arms are able to be resiliently displaced by a user pressing a cable between them; also a user can rotate one of the arms to create a space between them, pass a cable through the space and then return the arms to their previous position.

The present invention further provides a flat pack comprising a plurality of parts for assembly on site into a rack as defined above.

According to the invention there is also provided a cable guide suitable for securing to a cable guide mounting member of a rack suitable for housing connections of cables in a telecommunications or data communications network, the cable guide comprising a first end portion for mounting on the cable guide mounting member at a respective cable guide mounting, a cable guiding portion extending, in use, away from the mounting member and a second end portion provided at the opposite end of the cable guiding portion to the first end portion, the second end portion of the cable guide being provided with a radially extending arm, the radially outer end of which is resiliently displaceable.

The cable guide may incorporate any of the features of the cable guide defined above as part of a rack according to the invention. It will be understood that the cable guide preferably has a longitudinal axis which is substantially perpendicular to an elongate mounting member when the guide is mounted on the mounting member and that references to a direction towards the elongate mounting member therefore correspond to a direction parallel to the longitudinal axis of the cable guide.

The invention still further provides a method of making cable connections in a rack as defined above, including the step of guiding a cable around one or more of the plurality of cable guides. In the case where the second end portion is adjustable, the cable is preferably placed around a cable guide and thereafter the guide is adjusted to cause a part of the radially extending arm to overlie part of the cable.

By way of example, certain embodiments of the invention will now be described with reference to the accompanying drawings of which:

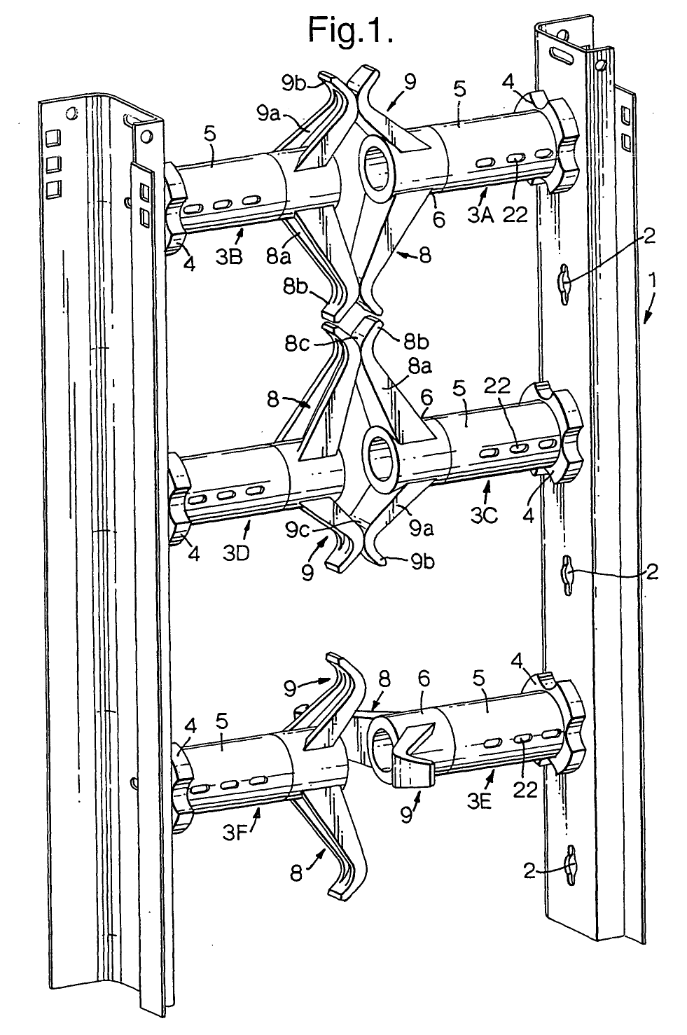

FIG. 1 is a perspective view of cable guides mounted on elongate mounting members of two racks (without side panels) positioned side by side,

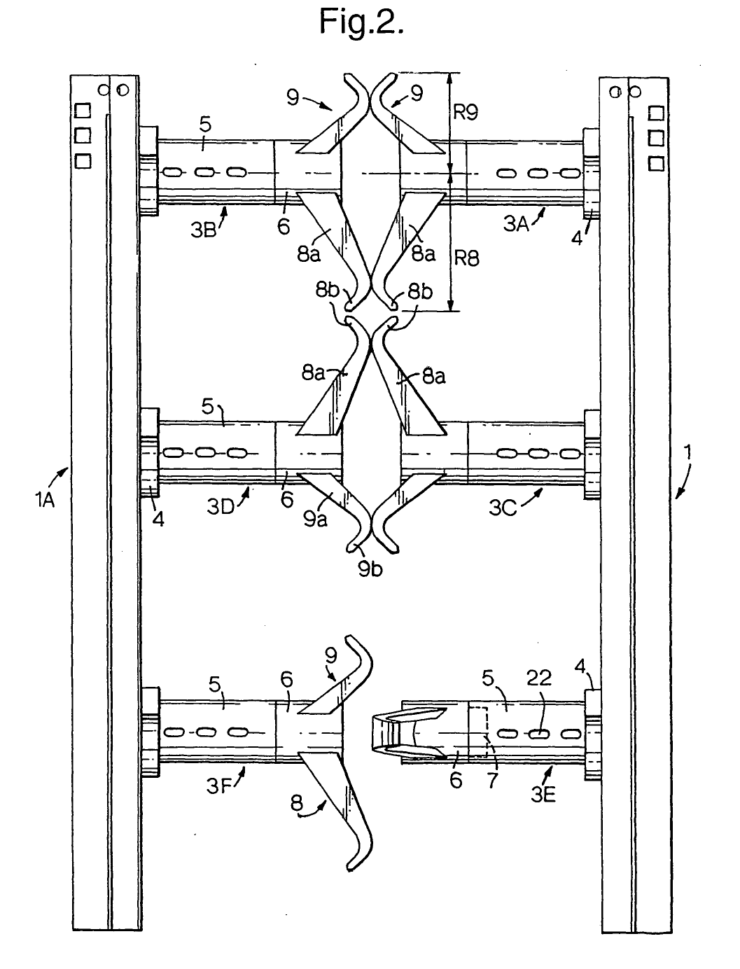

FIG. 2 is a front view of the arrangement shown in FIG. 1, and

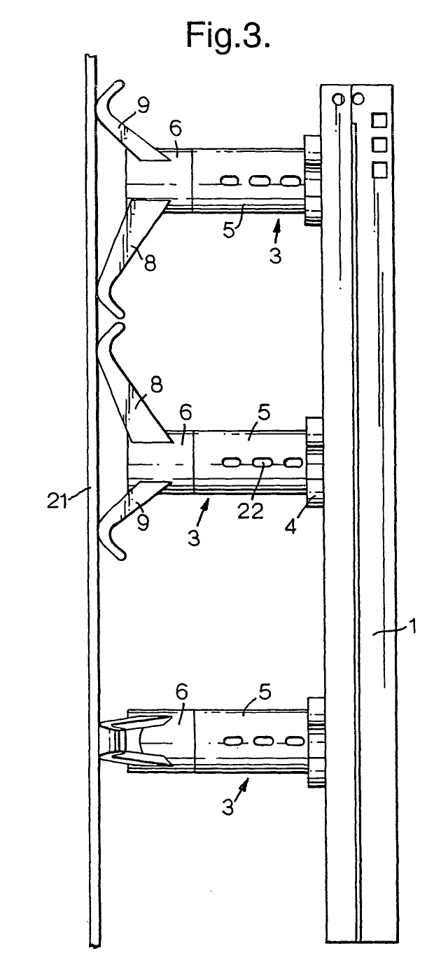

FIG. 3 is a front view of cable guides mounted on an elongate mounting member of a rack provided with a side panel.

Referring first to the right hand side of FIGS. 1 and 2, there is shown a mounting rail 1 including a series of holes 2 defining respective cable guide mountings and cable guides 3 mounted in three of the holes 2. It should be understood that only part of the length of the mounting rail 1 is shown in FIG. 1 and that the same arrangement is repeated along the length of the rack.

Each of the cable guides 3 comprises a first end portion (mounting portion) 4, a cable guiding portion 5 extending away from the mounting rail 1, and a second end portion (cable retaining portion) 6 provided at the opposite end of the cable guiding portion 5 to the mounting portion 4.

The structure of the mounting portion 4 is not shown in FIG. 1 but it may be substantially as shown in FIGS. 9 and 10 of our International Application No. PCT/GB 00/02484 (WO 01/01534) the contents or which is incorporated herein by reference. Thus the mounting portion 4 may be fastenable to the rail 1 by aligning a mounting head on the end of the cable guide with one of the holes 2, inserting the head through the hole and then rotating the cable guide through 90 degrees to lock the mounting portion 4 to the rail 1.

The cable guiding portion 5 is integral with the mounting portion 4 and may also be substantially of the same form as shown in FIGS. 9 and 10 of our International Application No. PCT/GB 00/02484 (WO 01/01534). Thus the portion 5 is of hollow cylindrical cross-section having apertures 22 in the wall of the guide portion, the apertures 22 serving as locations for cable ties, should they be desired. The distal end of the guide portion 5 is open and receives the cable retaining portion 6 which has a reduced diameter end portion 7 (shown in dotted outline in FIG. 2 for one of the cable guides) by which it fits closely in the guide portion 5 and is normally held by friction in a fixed position relative to the guide portion 5, but can be rotated by a user relative to the guide portion 5.

The cable retaining portion 6 is formed with two, integral, diametrically opposed arms 8,9. The arm 8 comprises a first root portion 8a which extends in a direction radially outwardly and away from the mounting rail 1, and a second end portion 8b which extends in a direction radially outwardly away from the root portion 8a and towards the mounting rail 1. Between the root and end portions 8a, 8b a smoothly curved bridging face 8c is provided and, as shown in the drawings, that face represents the part of the cable guide furthest from the mounting rail 1. The arm 9 is of the same general configuration as the arm 8, including a root portion 9a, an end portion 9b and a bridging face 9c. Although the arm 9 projects as far from the mounting rail 1 as the arm 8, it extends less far radially; more particularly, the radial extent of the arm from the longitudinal axis of the guide (the dimension marked as R8 in FIG. 2) is twice the radial extent of the arm 9 from the same axis (the dimension marked as R9 in FIG. 2).

The cable retaining portion is made of resiliently deformable material and the arms 8 and 9 are formed from thin web of the material so that they are able to be resiliently deformed under finger pressure of a user. The arms are thinner towards their ends and therefore more flexible in those regions. In one particular example of the invention the cable retaining portion is made of polypropylene.

FIGS. 1 and 2 show an arrangement of cable guides for the case where two racks are positioned side-by-side. The mounting rail 1, shown on the right hand side of FIGS. 1 and 2 is fixed to the left hand side of a first rack whilst the mounting rail 1A shown on the left hand side of FIGS. 1 and 2 is fixed to the right hand side of a second rack. As will be understood the structure of the mounting rail 1A is substantially the same as (strictly a mirror image of) the structure of the mounting rail 1 and it is also shown with three cable guides 3 mounted on it in confronting relationship to the cable guides on the mounting rail 1. The first and second racks are not shown; they may either be racks without side panels or racks in which one side panel has been removed. A further description of how the mounting rails 1 may be fixed to their racks is given in International Application No. PCT/GB 00/02484, with reference to FIGS. 12a and 12b.

For the purpose of describing the use of the cable guides 3, the six guides shown in FIGS. 1 and 2 are referenced 3A to 3F. It will be seen that guide 3A is opposite guide 3B and that they are in the same orientation with their arms 8,9 in contact with one another. Similarly the guide 3C is opposite guide 3D and those guides are in the same orientation as each other with their arms 8,9 in contact with one another. It should also be noted, however, that the orientation of the arms 8,9 on the guide 3A is opposite to that on the guide 3C and, similarly, the orientation of the arms 8,9 on the guide 3B is opposite to that on the guide 3D. In each case the longer arms 8 are directed towards one another with the result that the ends of the arms are immediately adjacent to one another.

The guide 3E is positioned opposite the guide 3F but in this case the orientation of the guides differs by 90° so that the arms 8,9 do not contact one another, allowing easy passage of a cable between the guides.

On occasion, perhaps when first connecting cables to racks, it may be desirable to position all the cable guides in the manner of the guides 3E and 3F, in order to facilitate the placing of cables in desired positions. After positioning of the cables the guides can be adjusted to the position of the guides 3A, 3B and 3C, 3D, in which cables passing between the cable guiding portions 5 of adjacent guides are retained securely within the region enclosed by the guides and the mounting rail. If it is desired to add a cable later, this can be done without adjusting the orientation of the guides: a user can for example introduce a cable from the top passing it between first the arms 9 of the guides 3A and 3B, then the arms 8 of the guides 3A and 3B and then, for example, between the arm 8 of the guide 3A and the arm 8 of the guide 3C. As will be understood from the description above, the arms deform resiliently to allow the cables to pass between them.

FIG. 3 shows the invention applied to a rack which has a side panel 21. In this case, the mounting rail 1 and the cable guides 3 are of exactly the same form as shown in the right hand side of FIGS. 1 and 2 and are referred to by the same reference numerals. The arms 8,9 of each cable guide contact the side panel 21 but a cable can be passed between the side panel and either of the arms by a user exerting finger pressure on the cable. It should be understood that the same rack may have a side panel on one side and employ the arrangement shown in FIG. 3, whilst being devoid of a side panel on the opposite side and being placed next to another rack on that side to create the arrangement shown in FIGS. 1 and 2.

1. A rack suitable for housing connections of cables in a telecommunications or data communications network, the rack including a plurality of cable guides mounted on an elongate cable guide mounting member on which a plurality of cable guide mountings are provided, each cable guide comprising a first end portion mounted on the mounting member at a respective cable guide mounting, a cable guiding portion extending away from the mounting member and a second end portion provided at the opposite end of the cable guiding portion to the first end portion, the second end portion of the cable guide being provided with a radially extending arm, the radially outer end of which is resiliently displaceable.

2. A rack according to claim 1, in which the radially extending arm is resiliently deformable to provide the resilient displacement of the radially outer end of the arm.

3. A rack according to claim 1 or 2, in which the radially outer end of the arm is resiliently displaceable in a direction towards the mounting member.

4. A rack according to any preceding claim, in which the radially outer end of the arm is resiliently displaceable in such a direction as to alter the radial extent of the arm.

5. A rack according to any preceding claim, in which the radially extending arm comprises a first root portion extending in a direction radially outwardly and away from the mounting member, and a second end portion extending in a direction radially outwardly away from the root portion and towards the mounting member.

6. A rack according to claim 5, in which a smoothly curved bridging face is provided on a face extending between the first root portion and the second end portion of the radially extending arm, the bridging face defining the portion of the arm furthest from the mounting member.

7. A rack according to any preceding claim, in which the part of the cable guide spaced furthest from the mounting member is a portion of the radially extending arm.

8. A rack according to claim 7, when dependent upon claim 6, in which the part of the cable guide spaced furthest from the mounting member is the bridging face of the radially extending arm.

9. A rack according to any preceding claim, in which the radially extending arm is a first arm and the second end portion of each cable guide is provided also with a second radially extending arm diametrically opposite the first arm.

10. A rack according to claim 9, in which the radially outer end of the second radially extending arm is resiliently displaceable.

11. A rack according to claim 10, in which the radially outer end of the second radially extending arm is resiliently displaceable in a direction towards the mounting member.

12. A rack according to claim 10 or 11, in which the radially outer end of the second radially extending arm is resiliently displaceable in such a direction as to alter the radial extent of the arm.

13. A rack according to any of claims 9 to 12, in which the radial extent of the second radially extending arm from the central axis of the cable guide is one half of the radial extent of the first radially extending arm from the central axis of the cable guide.

14. A rack according to any of claims 9 to 13, in which the ratio of twice the radial extent of the first radially extending arm from the central axis of the cable guide to the spacing of the cable guide mountings is approximately an integer.

15. A rack according to any preceding claim, in which the second end portion of the cable guide is adjustably mounted relative to the first end portion of the cable guide.

16. A rack according to claim 15, in which the second end portion of the cable guide is rotatably mounted relative to the first end portion of the cable guide.

17. A rack according to any preceding claim, the rack further including a side panel, the cable guides mounted on the elongate cable guide mounting member extending away from the mounting member towards the side panel with a part of the radially extending arm of each cable guide being disposed immediately adjacent to the side panel.

18. A rack according to claim 17, in which a part of the radially extending arm of each cable guide contacts the side panel.

19. A rack according to any preceding claim placed next to another rack also according to any preceding claim, elongate cable guide mounting members being provided on each of the racks in confronting relationship such that the radially extending arm of a cable guide on the mounting member of one rack can be disposed immediately adjacent to the radially extending arm of a cable guide on the mounting member of the other rack.

20. A rack according to claim 19, in which the radially extending arm of a cable guide on the mounting member of one rack is in contact with the radially extending arm of a cable guide on the mounting member of the other rack.

21. A flat pack suitable for assembling on site into a rack according to any of claims 1 to 20.

22. A cable guide suitable for securing to a cable guide mounting member of a rack suitable for housing connections of cables in a telecommunications or data communications network, the cable guide comprising a first end portion for mounting on the cable guide mounting member at a respective cable guide mounting, a cable guiding portion extending, in use, away from the mounting member and a second end portion provided at the opposite end of the cable guiding portion to the first end portion, the second end portion of the cable guide being provided with a radially extending arm, the radially outer end of which is resiliently displaceable.

23. A cable guide according to claim 22, in which the radially extending arm is resiliently deformable to provide the resilient displacement of the radially outer end of the arm.

24. A cable guide according to claim 22 or 23, in which the radially outer end of the arm is resiliently displaceable in a direction towards the mounting member.

25. A cable guide according to any of claims 22 to 24, in which the radially outer end of the arm is resiliently displaceable in such a direction as to alter the radial extent of the arm.

26. A cable guide according to any of claims 22 to 25, in which the radially extending arm comprises a first root portion extending in a direction radially outwardly and away from the mounting member, and a second end portion extending in a direction radially outwardly away from the root portion and towards the mounting member.

27. A cable guide according to claim 26, in which a smoothly curved bridging face is provided on a face extending between the first root portion and the second end portion of the radially extending arm, the bridging face defining the portion of the arm furthest from the mounting member.

28. A cable guide according to any of claims 22 to 27, in which the part of the cable guide spaced furthest from the mounting member is a portion of the radially extending arm.

29. A cable guide according to claim 28, when dependent upon claim 27, in which the part of the cable guide spaced furthest from the mounting member is the bridging face of the radially extending arm.

30. A cable guide according to any of claims 22 to 29, in which the radially extending arm is a first arm and the second end portion of each cable guide is provided also with a second radially extending arm diametrically opposite the first arm.

31. A cable guide according to claim 30, in which the radially outer end of the second radially extending arm is resiliently displaceable.

32. A cable guide according to claim 31, in which the radially outer end of the second radially extending arm is resiliently displaceable in a direction towards the mounting member.

33. A cable guide according to claim 31 or 32, in which the radially outer end of the second radially extending arm is resiliently displaceable in such a direction as to alter the radial extent of the arm.

34. A cable guide according to any of claims 30 to 33, in which the radial extent of the second radially extending arm from the central axis of the cable guide is one half of the radial extent of the first radially extending arm from the central axis of the cable guide.

35. A cable guide according to any of claims 22 to 34, in which the second end portion of the cable guide is adjustably mounted relative to the first end portion of the cable guide.

36. A cable guide according to claim 35, in which the second end portion of the cable guide is rotatably mounted relative to the first end portion of the cable guide.

37. A method of making cable connections in a rack according to any of claims 1 to 20, including the step of guiding a cable around one or more of the plurality of cable guides.
